(19) United States
(12) Patent Application Publication
(10) Pub. No.: US 2010/0079811 A1
(43) Pub. Date: Apr. 1, 2010

(54) Systems and Methods for Efficient Halftone Screening

(76) Inventor: Ken Ota, Cupertino, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/240,813

(22) Filed: Sep. 29, 2008

(51) Int. Cl. G06K 15/00

(52) U.S. Cl. 358/3.06

(57) ABSTRACT

Systems, methods, and devices described herein provide schemes for performing halftoning operations on image data using a first halftone pattern with a first data width on a SIMD-capable processor with a second data width, wherein second data width is not an integral multiple of the first data width. In some embodiments, the method can operate iteratively and comprises deriving a halftone pattern for an iteration based on a start location in the first halftone pattern, wherein the derived halftone pattern can be of the second data width; loading image data for the iteration until the image data is exhausted, or until the image data occupies the entire width of a register in the processor; and performing halftone computations on the image data using the derived halftone pattern.

### BACKGROUND

1. Technical Field

This description relates to the field of printing, and more specifically to systems and methods for the efficient halftone screening.

2. Description of Related Art

A halftone screen may be comprised of a pattern of dots of varying sizes applied to an image with tonal variations, or equal-size dots applied to a color image when printed. Digital halftoning typically uses spatially-periodic fixed size dots while varying the frequency of dot occurrence within halftone cells. Because printers do not have gray ink, they must use a set of strategically placed black dots to approximate a black and white image with tonal variations. When viewed from a distance, halftoning appears to the human eye as very similar to a continuous toned image. The human eye averages the information within a halftone cell and sees an apparent “gray-level,” which can be approximated as the ratio of inked to non-inked areas within the cell. The human eye also averages the changes in “gray-level” between adjacent equally-spaced cells, so that the image creates the illusion of being a continuous-toned image.

In most modern printers, the size of a halftone cell is a tradeoff between the resolution of the halftone screen (often expressed in lines of dots per inch or “lpi”) and the maximum printer resolution (often expressed in dots per inch or “dpi”). Because a halftone cell is composed of a number of laser printer dots, the use of a larger halftone cell permits a smoother representation of tonal variations within the cell but creates more abrupt transitions between cells. Conversely, when the halftone cell is of a smaller size, the expression of tonal variations within the cell is limited but variations between cells are less abrupt. For example, if the halftone resolution was selected to be 60 lpi for a printer with a maximum resolution of 600 dpi, each halftone cell would measure 600/60=10 pixels wide. The halftone grid could be 10×10 or 100 laser printer dots and allow the representation of 100 different gray-scale values for a black and white image. For color images, halftoning would be performed for each color plane and the halftone grid above would allow the representation of 100 distinct tonal variations for each plane.

Typically, halftoning is performed in modern printers by repeatedly applying the halftone pattern or screen to a higher resolution image to obtain a lower resolution image. In many printers, halftoning may take advantage of the processing capabilities of a digital signal processor (“DSP”). Many modern DSPs support Single Instruction Multiple Data (“SIMD”) type parallelism. In SIMD parallelism, a single instruction operates on multiple data streams. For example, a compare operation may be performed on four different data operands in a single instruction cycle and yield four results simultaneously.

Because the same halftone pattern is repeatedly applied to different sections of an image in memory, halftoning is well-suited to SIMD parallelism. However, because sizes of halftone cells may not correspond to the data-sizes supported by the DSP, the use of processing units with the DSP will not be optimal. The data-width of a DSP is the maximum size of data that can be processed by the DSP in a single instruction cycle. Typically, the data width of a DSP is a power of 2, and the data-width can vary from 4 bytes to 256 bytes depending on the DSP.

For instance, performing DSP operations on a SIMD DSP with a 128-bit (16-byte) data width for a 10×10 halftone cell where each pixel is 1-byte long would theoretically permit 16 pixels (128-bits) to be processed in parallel. However, because processing in normally structured by the size of the halftone cell, for the example above, only 10 pixels would be processed in parallel. However, such a division leads to 6-bytes out of 16 being unused during the processing of each cell leading to sub-optimal DSP utilization that can affect printer performance. Thus, there is a need for systems and methods to optimize halftoning operations to permit better utilization of the processing capabilities offered by DSPs that support SIMD operations.

### SUMMARY

Consistent with disclosed embodiments, systems, methods, and devices are presented for performing halftoning operations on image data using a first halftone pattern with a first data width on a SIMD-capable processor with a second data width, wherein second data width is not an integral multiple of the first data width. In some embodiments, the method can operate iteratively and comprises deriving a halftone pattern for an iteration based on a start location in the first halftone pattern, wherein the derived halftone pattern can be of the second data width; loading Image data for the iteration until the image data is exhausted, or until the image data occupies the entire width of a register in the processor; and performing halftone computations on the image data using the derived halftone pattern.

Embodiments disclosed also pertain to programs encoded in computer-readable media and memory. These and other embodiments are further explained below with respect to the following figures.

### BRIEF DESCRIPTION OF THE DRAWINGS

FIG. 1 shows a block diagram of an exemplary system for halftoning.

FIG. 2 shows a portion of an exemplary process flow for processing a print file.

FIG. 3A illustrates an exemplary 2-bit halftone encoding of pixel data values using an exemplary halftone lookup table.

FIG. 3B illustrates an exemplary approach to convert exemplary 8-bit pixel values to 2-bit halftone encoded data.

FIG. 4 illustrates a single register in an exemplary DSP 179 or CPU 176 with a 128-bit data width that is capable of being partitioned for SIMD operations.

FIG. 5 shows a block diagram indicating data flow in a traditional system using SIMD-operations for exemplary halftone encoding.

FIG. 6A shows an exemplary halftone pattern distribution for a plurality of iterations in a DSP 179 configured for SIMD operations consistent with disclosed embodiments.

FIG. 6B shows another halftone pattern distribution example, with DSP 179 data width B=16, image width W=50, and halftone screen size of 3×3, corresponding to halftone screen width of M=3.

FIG. 7 shows a flowchart for an exemplary method for halftoning for a single row of an image consistent with disclosed embodiments.

### DETAILED DESCRIPTION

Consistent with disclosed embodiments, systems, methods, and devices are presented for performing halftoning operations on image data on a SIMD-capable processor.

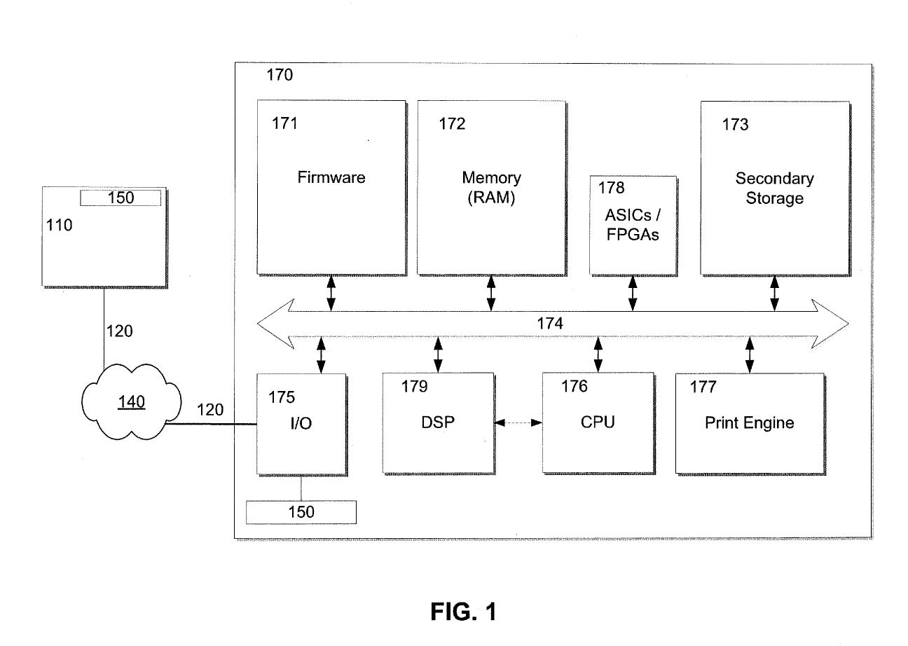

FIG. 1 shows an exemplary block diagram of a system for halftoning. A computer software application consistent with disclosed embodiments may be deployed on one or more computers, or printers, such as the system shown in FIG. 1, that are connected through communication links that allow information to be exchanged using conventional communication protocols and/or data port interfaces.

As shown in FIG. 1, exemplary system 100 includes a computing device 110, network 140, and printer 170. Further, computing device 110 and printer 170 may communicate using network 140, which in one case could be the Internet. Computing device 110 may be a computer workstation, desktop computer, laptop computer, or any other computing device capable of being used in a networked environment. Printer 170 may be a platform capable of connecting to computing device 110 and other devices too (not shown). Computing device 110 and printer 170 may be capable of executing software (not shown) that allows the control and configuration of processing operations performed on printer 170.

Computing device 110 and/or printer 170 may contain removable media drive 150. Removable media drive 150 may include, for example, portable hard drives, CD-ROM drives, DVD ROM drives, CD±RW or DVD±RW drives, USB™ flash drives, memory sticks, floppy drives, and/or any other removable media drives consistent with disclosed embodiments. Portions of software applications may reside on removable media and be read and executed by computing device 110 or printer 170 using removable media drive 150. In some embodiments, results or reports generated by applications may also be stored on removable media.

Connection 120 couples computing device 110 and printer 170 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB™, SCSI, FIREWIRE™, serial, and/or parallel ports for transmission of data through the appropriate connection 120. The communication links could be wireless links or wired links or any combination that allows communication between computing device 110, and printer 170.

Network 140 could include a Local Area Network (LAN), a Wide Area Network (WAN), or the Internet. Exemplary printer 170, may be a network printer, and can be coupled to network 140. In some embodiments, a printing device, such as exemplary printer 170, may be a local or dedicated printer and connected directly to computing device 110 and/or other peripherals (not shown). Printing devices, such as exemplary printer 170, may also have removable media drivel 50, as shown in FIG. 1. System 100 may include multiple printing devices and other peripherals (not shown), consistent with disclosed embodiments.

Printer 170 may be controlled by hardware, firmware, or software, or some combination thereof. Printing devices 170 may be controlled by firmware or software resident on memory devices in print controllers 175. In general, print controllers 175 may be internal or external printer 170. In some embodiments, printer 170 may also be controlled in part by software, such as a print driver running on computing device 110.

Exemplary printer 170 may contain bus 174 that couples Central Processing Unit (“CPU”) 176, DSP 179, firmware 171, memory 172, input-output ports 175, print engine 177, removable media drive 150, and secondary storage device 173. Exemplary Printer 170 may also contain other Application Specific Integrated Circuits (ASICs), and/or Field Programmable Gate Arrays (FPGAs) 178 that are capable of executing portions of an application to print or process documents. Exemplary printer 170 may also be able to access secondary storage or other memory in computing device 110 using I/O ports 175 and connection 120. In some embodiments, printer 170 may also be capable of executing software including a printer operating system and other appropriate application software. Exemplary printer 170 may allow paper sizes, output trays, color selections, and print resolution, among other options, to be user-configurable.

Exemplary CPU 176 may be a general-purpose processor, a special purpose processor, or an embedded processor. CPU 176 can exchange data including control information and instructions with memory 172 and/or firmware 171. In some embodiments, CPU 176 may support SIMD-type instructions and may be capable of executing algorithms using SIMD operations, such as an algorithm for halftoning. For example, a printer driver running on computer 110 may use SIMD instructions supported by the CPU on computer 110 to perform halftoning operations in a manner consistent with disclosed embodiments.

DSP 179 may be coupled to CPU 176 and may operate under the control of CPU 176. In one embodiment, CPU176 may indicate the type of processing to be performed, and the location and bounds of data in memory 172 to DSP 179. DSP 179 may fetch the data, perform the requested operations, store the results in a memory location, and indicate the location of the results to CPU 176. In some embodiments, DSP 179 may send the results directly to CPU 176. In some embodiments, DSP 179 may be capable of performing operations in parallel on data operands. For example, DSP 179 may support SIMD-type instructions and perform SIMD-type operations on its operands when executing halftoning in a manner consistent with disclosed embodiments. In some embodiments, printer 170 may contain additional or fewer components and the systems and methods disclosed may be modified appropriately. For example, CPU 176 may perform halftoning using SIMD-type instructions, if DSP 179 is not present. In some embodiments, the CPU on computer 110 may support SIMD-type instructions and may also be used to perform halftoning operations in parallel.

Memory 172 may be any type of Dynamic Random Access Memory (“DRAM”) such as but not limited to SDRAM, or RDRAM. Firmware 171 may hold instructions and data including but not limited to a boot-up sequence, pre-defined routines including routines for image processing, trapping, document processing, and other code. In some embodiments, code and data in firmware 171 may be copied to memory 172 prior to being acted upon by CPU 176. Routines in firmware 171 may include code to translate page descriptions received from computing device 110 to display lists. In some embodiments, firmware 171 may include rasterization routines to convert display commands in a display list to an appropriate rasterized bit map and store the bit map in memory 172. Firmware 171 may also include compression, trapping, and memory management routines. Data and instructions in firmware 171 may be upgradeable using one or more of computer 110, network 140, removable media coupled to printer 170, and/or secondary storage 173.

Exemplary CPU 176 may act upon instructions and data and provide control and data to ASICs/FPGAs 178 and print engine 177 to generate printed documents. ASICs/FPGAs 178 may also provide control and data to print engine 177. DSP 179 and/or FPGAs/ASICs 178 may also implement portions of one or more of translation, trapping, compression, and rasterization algorithms.

Exemplary secondary storage 173 may be an internal or external hard disk, memory stick, or any other memory storage device capable of being used by system 200. In some embodiments, the display list may reside and be transferred between one or more of printer 170, computing device 110, and server 130 depending on where the document processing occurs. Memory to store display lists may be a dedicated memory or form part of general purpose memory, or some combination thereof. In some embodiments, memory to hold display lists may be dynamically allocated, managed, and released as needed. Printer 170 may transform intermediate printable data into a final form of printable data and print according to this final form.

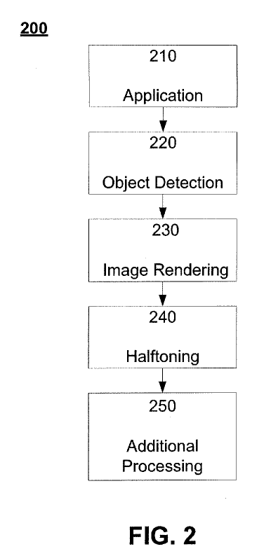

FIG. 2 shows an exemplary process flow 200 for processing a print file. As shown in FIG. 2, a printer file generated by exemplary application 210 is processed by object detecting module 220. Exemplary application 210 may be a document processing application such as Word, Adobe Acrobat, or any other application capable of generating printable output. Printer files can be multi-object files comprising image data, graphics data, and text data. Exemplary computing device 110 may transform document data into a first printable data. In some embodiments, the first printable data may correspond to a PDL description of a document. Then, the first printable data can be sent to printer 170 for transformation into intermediate printable data.

In some embodiments, the translation process from a PDL description of a document to the final printable data comprising of a series of lower-level printer-specific commands may include the generation of intermediate printable data comprising of display lists of objects. Display lists may hold one or more of text, graphics, and image data objects and one or more types of data objects in a display list may correspond to an object in a user document. Display lists, which may aid in the generation of intermediate printable data, may be stored in memory 172 or secondary storage 173. Object detecting module 220 may generate command level code, which is received by an image rendering module 230.

In some embodiments, exemplary image rendering module 230 produces pixel data of a first size, which may be converted to encoded data of a second size using halftoning 240. For example, a threshold halftone lookup table may be used to perform the halftoning and reduce 8-bit pixel data to 4-bits. Halftoning 240 may be used to convert a continuous-toned image to an image rendered by using a series of strategically placed dots. In order to simulate gradations of light or color, the relative density of dots per given cell size, dots per inch (“dpi”) is varied. A higher density of dots creates a darker image portion.

Standard halftoning techniques allow image file sizes to be reduced but may also lead to degradation in the quality of printed images. For example, an 8-bit pixel may be converted to 4-bit encoded halftone data. 8 bits can represent 256 values, while 4 bits can represent 16. Therefore, one mechanism to convert 8-bit data to 4-bit data may quantize the 8-bit data into one of 16 ranges, such as 0-15, 16-31, 32-47 . . . 226-239, 240-255. Each of the 16 ranges may be assigned a distinct value from 0 through 15 in the 4-bit space. Once the range of the 8-bit value of a pixel has been determined, the pixel may be assigned the 4-bit value corresponding to that range. Various other halftoning schemes are also well-known, and the disclosed embodiments may be applied to these schemes by appropriate modification as would be apparent to one of skill in the art.

One halftoning method may compare a pixel value to a corresponding set of values in a threshold halftone lookup table. For example, 8-bit pixel data may take on a new 4-bit value by comparing it with multiple threshold values and converting the logical result into a 4-bit binary number. In some embodiments, binary search algorithms and other well-known techniques may be used to limit the number of comparisons. Halftone conversion decreases the size of the data file by decreasing the bit-size per pixel and creates an encoded printer file, which is usable by printer 170 to print the desired image.

In some embodiments, the encoded data may be output for additional processing to downstream modules and/or processes 250. For example, in one embodiment, if the operations have been performed using a print driver running on a CPU in computing device 110, then the data may be compressed prior to being sent to printer 170. In another embodiment, if the operations are performed on a printer, then it may be sent for additional processing, such as trapping, prior to being printed on a print medium using print engine 177.

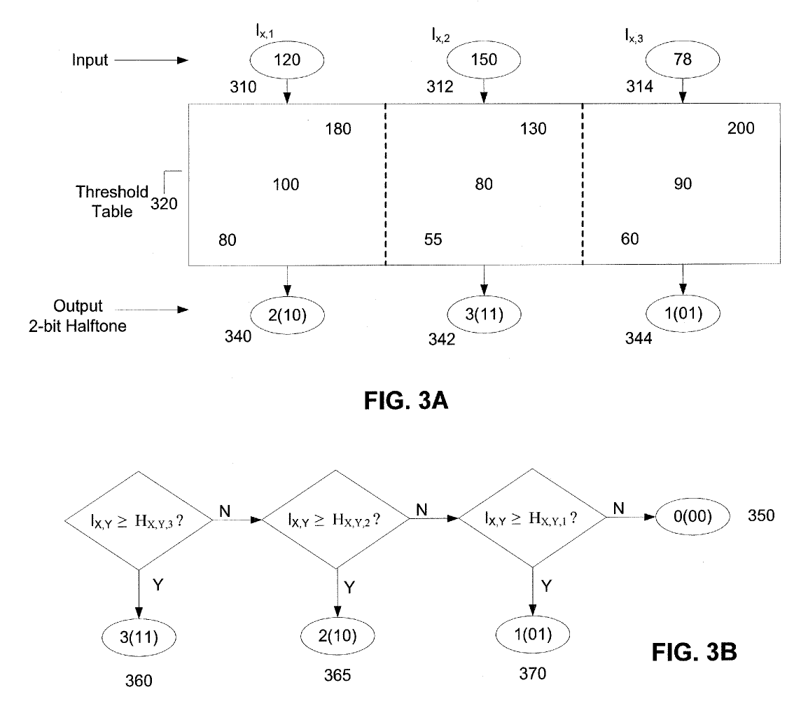

FIG. 3A illustrates an exemplary 2-bit halftone encoding of pixel data values using an exemplary halftone lookup table. As shown in FIG. 3A, three exemplary 8-bit input pixels I_{x,1} 310, I_{x,2} 312, and I_{x,3} 314 have values 120, 150, and 78, respectively. Exemplary conventional 2-bit threshold halftone lookup table 320 comprises three threshold values for each pixel. In the example illustrated in FIG. 3A, the three threshold values H_{x,y,3}, H_{x,y,2}, and H_{x,y,1} for I_{x,1} 310 are 180, 100, and 80, respectively. The threshold values may be used convert 8-bit pixel I_{x,1} to 2-bits.

FIG. 3B illustrates an exemplary approach to convert exemplary 8-bit pixel values to 2-bit halftone encoded data. In some embodiments, the process illustrated in FIG. 3B may be applied to each pixel I_{x,y}. The process is described below for pixels I_{x,1} 310, I_{x,2} 312, and I_{x,3} 314. In step 360, if I_{x,y} is greater than H_{x,y,3}, then the resulting 2-bit encoded value may be set to 3 or [11]₂. If pixel value I_{x,y} is not greater than H_{x,y,3}, then the pixel value is compared to H_{x,y,2}, in step 365. If I_{x,y} is greater than H_{x,y,2}, then the encoded value may be set to 2 or [10]₂. If pixel value I_{x,y} is not greater than H_{x,y,2} then the pixel value is compared to H_{x,y,1}, in step 370. If I_{x,y} is greater than H_{x,y,1}, then the encoded value may be set to 1 or [01]₂. In step 350, I_{x,y} has been determined to be less than all three threshold values, resulting in an encoded 2-bit value of 0 or [00]₂. The process above is also applied to I_{x,1} 310, I_{x,2} 312, and I_{x,3} 314. Consequently, pixel I_{x,1} 310 with a value 120 is greater than H_{x,y,2}, which has a value of 100. Therefore pixel I_{x,1} 310 is encoded as 2 or [10]₂. Similarly, the comparison operations yield an encoded value of 3 or [1]₂ for pixel I_{x,2} 312, and an encoded value of 1 or [01]₂ for pixel I_{x,3} 314.

Note that the process described above may be carried out in parallel by using SIMD type operations on CPU 176 or DSP 179. The data width of CPU 176 or DSP 179 may be partitioned so that multiple operands may be compared in parallel.

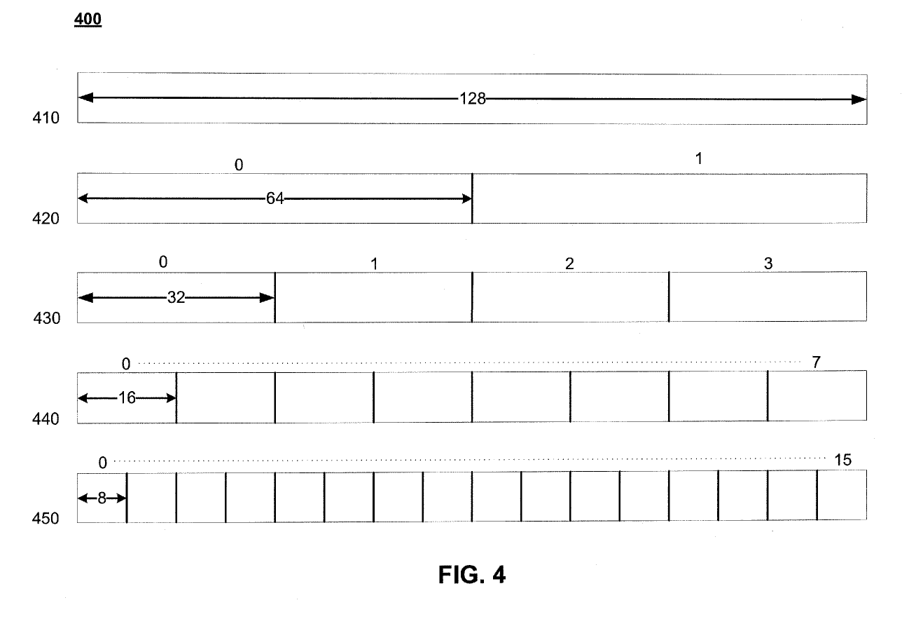

FIG. 4 illustrates a single register 400 in an exemplary DSP 179 or CPU 176 with a 128-bit data width that is capable of being partitioned for SIMD operations. As shown in FIG. 4, when the register is not partitioned 410, register 400 may be capable of holding a single operand of 128-bit data width. When 64-bit operands are encountered the register may be partitioned into two sub-registers 420 each holding one 64-bit operand and operations may be carried out in parallel on the two operands. Similarly, as also shown in FIG. 4, register 400 may be partitioned into four sub-registers 430, 8 sub-registers 440, and 16 sub-registers 450, to operate on four 32-bit, eight 16-bit, and sixteen 8-bit operands in parallel, respectively.

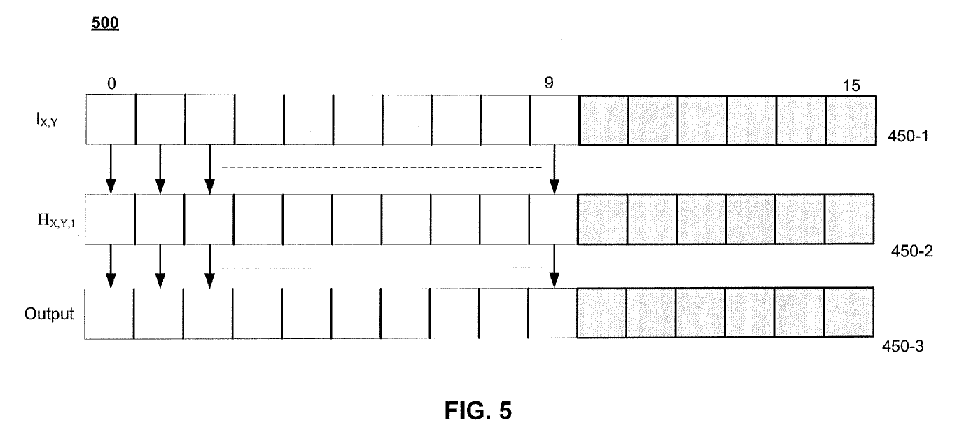

FIG. 5 shows a block diagram 500 indicating data flow in a traditional system using SIMD-operations for exemplary halftone encoding. As shown in FIG. 5, register 400 can be divided into 16 sub-registers 450 each containing an 8-bit pixel for halftone encoding. As shown in FIG. 5, the halftone screen can be 10 pixels wide. Accordingly, each pixel I_{x,y} [0] through I_{x,y} [9] in sub-registers 450-1 can be compared with its corresponding threshold value H_{x,y,1} [0] through H_{x,y,1} [9] in sub-registers 450-2 simultaneously in a single processor cycle for the instruction type and the encoded result can be placed in corresponding output sub-register 450-3. However, as shown in FIG. 5, this can result in sub-registers 11 through 15 not being utilized.

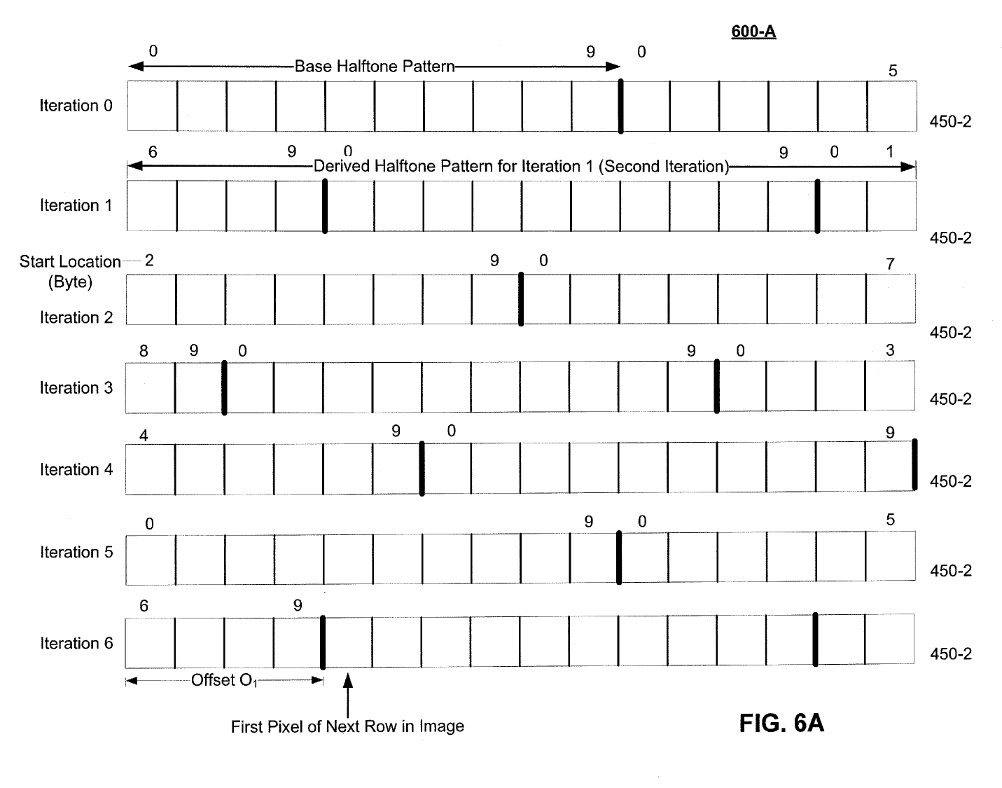

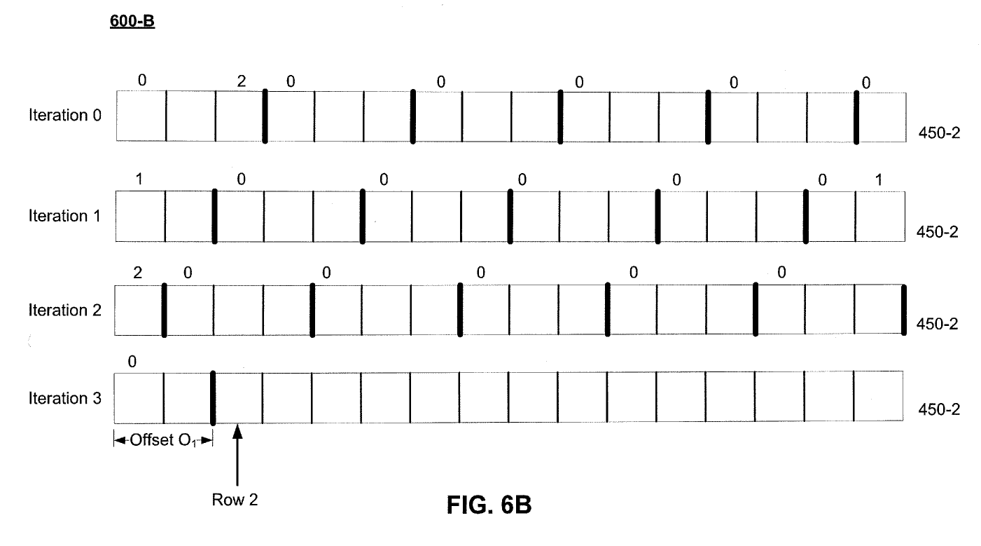

FIG. 6A shows an exemplary halftone pattern distribution 600-A for a plurality of iterations in a DSP 179 configured for SIMD operations consistent with disclosed embodiments. In FIG. 6A, for simplicity and illustrative purposes only each pixel is assumed to be 1-byte wide. Modifications to the algorithms disclosed will be apparent to persons of ordinary skill in the art for other pixel word sizes. Further as shown in FIG. 6A, exemplary DSP 179 data width B is 16-bytes, the halftone screen width M is 10 bytes corresponding to a 10×10 halftone screen, and the image width W is assumed to be 100 pixels.

Each row in FIG. 6A shows register 450-2, which contains the halftone pattern, during an iteration of algorithm for halftoning according to disclosed embodiments. As shown in FIG. 6A, each cell corresponds to byte in register 450-2. The value of iteration counter i for an iteration is indicated to the left. The beginning of the next halftone pattern (or the end of the prior pattern) in the DSP 179 register or buffer is demarcated by the heavy weighted line. The numbers on top of the cells indicate byte numbers in the halftone pattern. For example, “0” indicates the first byte and “9” indicates the last byte.

The base halftone pattern comprises the contents of cells 0 through 9 of iteration 0. As shown in FIG. 6A, a derived halftone pattern may be obtained from the base halftone pattern. The derived halftone pattern is distributed across register 450-2 so that the entire width of register 450-2 is used. A derived halftone pattern may be computed for each iteration based by determining a start location in the base halftone pattern for an iteration, and using the start location to obtain the derived halftone pattern. In some embodiments, the derived halftone pattern for an iteration may be obtained by: (a) taking the portion of the base halftone pattern from the start position to the end; (b) repeatedly concatenating the base halftone pattern to the portion obtained in step (a) above; and (c) truncating the tail of concatenated pattern obtained in step (b) above so that the pattern fits in to the data width B of the DSP. The numbers on the top of the first cell for each iteration represent the start (byte) position for the halftone pattern.

For example, for the first iteration, where iteration counter i=0, bytes 0 through 9 hold the halftone pattern and subsequent cells (10 through 15) of register 450-2 hold bytes 0-5 of the halftone pattern. Because the halftone pattern is successively repeated using the entire width of the register, to ensure correct computation of halftone values, the halftone pattern for the next iteration can be adjusted to start at an appropriate start location (byte, pixel, bit etc.) in the halftone pattern. Thus, the derived halftone pattern can occupy the entire width of the register. During the computation, appropriate pixel values will be loaded into register 450-1 (not shown) and halftone values may be computed based on the halftoning scheme used.

Accordingly, as shown in FIG. 6A, for the second iteration, where iteration counter i=1, the halftone pattern starts at byte 6. For the second iteration, the 16 cells shown for register 450-2 contain bytes 6-9 of the halftone pattern, followed by bytes 0-9 of the halftone pattern, followed again by bytes 0-1 of the pattern, respectively. Again, for the second iteration appropriate pixels can be loaded into register 450-1 for the halftone computation. Note that for the second iteration, where the start byte is 6, the derived halftone pattern can be obtained by (i) taking bytes 6 through 9 of the base halftone pattern, (ii) concatenating the base halftone pattern twice to the pattern in (i) above and (iii) truncating the last 8 bytes of the concatenated pattern to obtain the derived pattern.

Note that in processors where a “rotate” operation is available, the derived pattern may also be obtained in some embodiments by: (1) rotating the first halftone pattern by R bits to obtain a second halftone pattern, wherein R represents the bit position of the start location in the first halftone pattern for the iteration; (2) repeatedly concatenating the second halftone pattern to obtain a concatenated pattern that is greater than or equal to the second data width; and (3) truncating any terminal portion of the concatenated pattern so that the resulting derived pattern is of the second data width. For the examples above, for R=1, for iteration 0 (the first iteration) and R=48 for iteration 1 (the second iteration). Because the derived pattern for the second iteration starts at byte 6 (the 7^{th} byte), and each byte is 8-bits wide, the base pattern can be rotated by R=8×6=48 bits in step (1) above.

In some embodiments, the process described above may be repeated for each row of pixels in an image. In general, in order to process a single row of pixels, or a scanline in an image, of width W, the process is repeated N times, where N is the smallest integer that satisfies,

$$N \geq \frac{W}{B} , \qquad ( 1 )$$

and B is the data-width of the DSP 179. Accordingly, for the example in FIG. 6A, with B=16 and W=100, N=7, and therefore 7 iterations are used to process a single row in the image. FIG. 6A shows where the halftone pattern for a single row would end in iteration 6. In some embodiments, the next row may begin during the next iteration. In some embodiments, the halftone pattern for the next row can be repeated immediately after the end of the prior row.

Further, the starting byte S for each iteration i can be calculated as

S=(i,*B)mod M (2),

where, “mod” refers to the operator that yields the remainder after integer division, and B is the data-width of the DSP 179. Accordingly, as i varies from 1 through 6, the starting byte for the corresponding iteration can be calculated using equation (2), which yields S=6, 2, 8, 4, 0, and 6 when i=1, 2, 3, 4, 5, and 6, respectively. In some embodiments, equation (2) may be used to calculate the starting byte S of the halftone pattern for each iteration.

In some embodiments, where the processing of each row in the image may be started afresh, as a new iteration, equation (2) may be used to calculate the starting byte for each iteration by resetting iteration counter i to 0. In some embodiments, the halftone pattern for the next row in the image may immediately follow the end of the prior row, and the iteration counter i increases monotonically until all rows in the image have been processed. In such embodiments, the offset Oₖ corresponding to the start of row k in the image, where the first row is given by k=0, can be computed as

Oₖ=(k,*W)mod B (3).

Oₖ may be useful to identify pixels in register 450-1 that correspond to start of new rows. By using equation (3), for the second row, where k=1, in the example in FIG. 6A, the offset O₁=(1*100) mod 16=100 mod 16=4. Therefore, for the example in FIG. 6A, byte 4 in register 450-1 would hold the start pixel for the second row in the image.

Note that conventionally (as shown in FIG. 5), halftone processing using a 10×10 screen for an image width 100 and a DSP 179 data width of 16 bytes would take 10 iterations. By using the method disclosed with relation to FIG. 6A, only 7 iterations are needed. Further, if the image has a 100 rows, then the conventional algorithm would take 10*100=1000 iterations, whereas the method disclosed above would take (100/16)*100=625 iterations.

FIG. 6B shows another example, with DSP 179 data width B=16, image width W=50, and halftone screen size of 3×3, corresponding to halftone screen width of M=3. Using equation 1, N=4. Therefore, as shown in FIG. 6B, 4 iterations with iteration counter i varying from 0 to 3 may be used to process one row of the image. Further, as i varies from 1 through 3, the starting byte for the corresponding iteration can be calculated using equation (2), which yields S=1, 2, and 0, when i=1, 2, and 3, respectively. By using equation (3), for the second row, where k=1, in the example in FIG. 6B, the offset O₁=(1*50) mod 16=50 mod 16=2. Therefore, for the example in FIG. 6B, byte 2 in register 450-1 would hold the start pixel for the second row in the image. Note that because the image width W=50 is not an integral multiple of the halftone width M, the last halftone pattern has been truncated to two bits. In some embodiments, the entire halftone pattern may be used and the computations for unused halftone values may be discarded.

Because, S takes on a finite set of values for a given data width B and halftone size M the halftone patterns in the iterations will repeat every (B mod M) iterations. Accordingly, in some embodiments, a halftone pattern starting at the correct byte for the values 0 through [(B mod M)−1] may be stored in a table and directly loaded into register 450-2 based on the pattern needed for that iteration. For example, the halftone pattern shown for each iteration 0 through 5 in FIG. 6A may be stored in a table in rows 0 through 5, respectively of the table. The appropriate pattern may be accessed based on the value of (i mod B) and used for halftoning computations.

In some embodiments, one or more of the above halftone patterns starting at the correct byte may be pre-computed and stored in registers in a register file in the DSP 179. The appropriate register in DSP 179 may then be used as operand in halftoning computations. In some embodiments, the above patterns may be stored in a high-speed memory or cache and loaded into register when used.

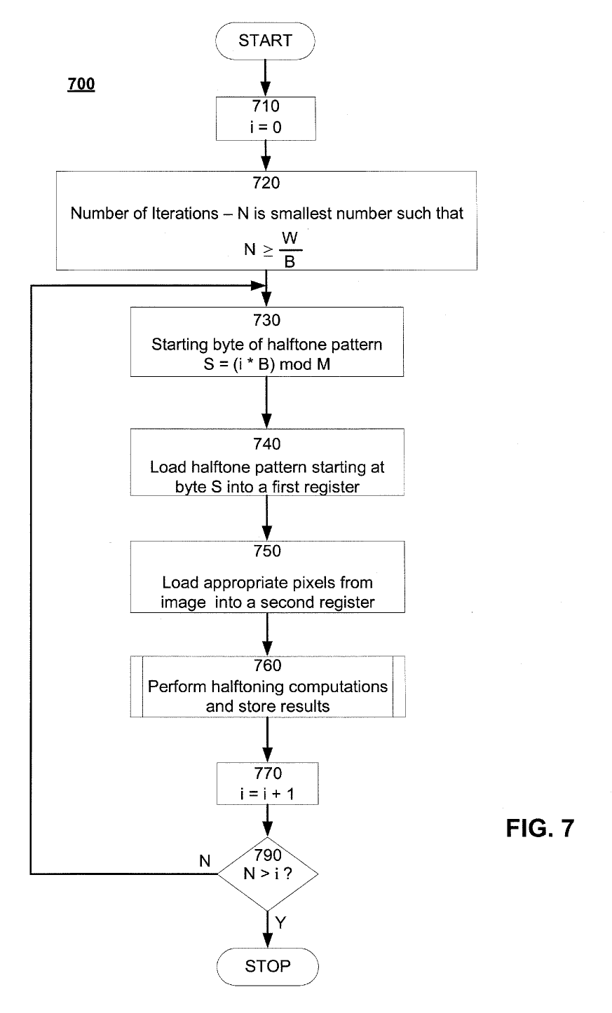

FIG. 7 shows a flowchart for an exemplary method for halftoning for a single row of an image consistent with disclosed embodiments. In step 710, the value of iteration counter i may be initialized to 0. Next, in step 720, the number of iterations N may be calculated according to equation (1). In step 730, the value of the starting byte S for the current value of iteration counter i may be calculated according to equation (2). In some embodiments, the appropriate halftone pattern with starting byte S may be loaded from a table into a register on DSP 179 or CPU 176. In step 750, the pixel values for halftoning may be loaded into a second register on DSP 179 or CPU 176. In routine 760 halftoning computations may be performed according to the halftoning algorithm in use and the results may be stored. Next, in step 770, the value of the iteration counter is incremented. In step 780, the value of iteration counter is compared with N. If N>i, then the algorithm may terminate, otherwise the algorithm may return to step 730 for a subsequent iteration.

Further, methods consistent with disclosed embodiments may conveniently be implemented using program modules, hardware modules, or a combination of program and hardware modules. Such modules, when executed, may perform the steps and features disclosed herein, including those disclosed with reference to the exemplary flow charts shown in the figures. The operations, stages, and procedures described above and illustrated in the accompanying drawings are sufficiently disclosed to permit one of ordinary skill in the art to practice the disclosed embodiments and variants.

The above-noted features and aspects may be implemented in various environments. Such environments and related applications may be specially constructed for performing the various processes and operations, or they may include a general-purpose computer or computing platform selectively activated or reconfigured by program code to provide the functionality. The processes disclosed herein are not inherently related to any particular computer and printing apparatus and aspects of these processes may be implemented by any suitable combination of hardware, software, and/or firmware. For example, various general-purpose machines may be used, or it may be more convenient to reconfigure or construct a specialized printing apparatus or system to perform the methods and techniques.

Embodiments also relate to computer-readable media that include program instructions or program code for performing various computer-implemented operations consistent with disclosed methods, processes, and embodiments. The program instructions may be those specially designed and constructed, or they may be of the kind well known and available to those having skill in the computer software arts. Examples of program instructions include, for example, machine code, such as produced by a compiler, and files containing a high-level code that can be executed by the computer using an interpreter, firmware, and microcode.

Other embodiments will be apparent to those skilled in the art from consideration of the specification and practice of the embodiments disclosed herein. It is intended that the specification and examples be considered as exemplary only, with a true scope and spirit being indicated by the following claims. As such, the invention is limited only by the following claims.

1. A method for performing halftoning operations on image data using a first halftone pattern with a first data width on a SIMD-capable processor with a second data width, wherein the method comprises at least one iteration and the second data width is not an integral multiple of the first data width, the method comprising:
deriving a halftone pattern for the iteration based on a start location in the first halftone pattern, wherein the derived halftone pattern is of the second data width;
loading image data for the at least one iteration into a register in the processor, until the image data is exhausted, or until the width of the image data equals the second data width; and
performing halftone computations on the image data using the derived halftone pattern.

2. The method of claim 1, wherein deriving a halftone pattern for the iteration based on a start location in the first halftone pattern further comprises:
rotating the first halftone pattern by R bits to obtain a second halftone pattern, wherein R is the bit position of the start location in the first halftone pattern for the iteration;
repeatedly concatenating the second halftone pattern to obtain a concatenated pattern that is greater than or equal to the second data width; and
truncating any terminal portion of the concatenated pattern so that the resulting derived pattern is of the second data width.

3. The method of claim 1, wherein the method is performed using a Digital Signal Processor coupled to a printer.

4. The method of claim 1, wherein the halftoning operations include threshold halftoning.

5. The method of claim 2, further comprising storing distinct derived halftone patterns that correspond to distinct start locations in the first halftone pattern in a table.

6. The method of claim 2, further comprising storing distinct derived halftone patterns that correspond to distinct start locations in the first halftone pattern in distinct processor registers.

7. The method of claim 1, wherein the method is used to perform halftoning operations on at least one entire image.

8. The method according to claim 5, wherein the table is stored in memory internal to a printer.

9. The method of claim 1, wherein the method is performed using one or more of:
a computer coupled to a printer;
a print controller coupled to a printer; and
a printer.

10. A computer-readable medium that stores instructions, which when executed by processor perform steps in a method for performing halftoning operations on image data using a first halftone pattern with a first data width on a SIMD-capable processor with a second data width, wherein the method comprises at least one iteration and the second data width is not an integral multiple of the first data width, the steps comprising:
deriving a halftone pattern for the iteration based on a start location in the first halftone pattern, wherein the derived halftone pattern is of the second data width;
loading image data for the at least one iteration into a register in the processor, until the image data is exhausted, or until the width of the image data is equal to the second data width; and
performing halftone computations on the image data using the derived halftone pattern.

11. The computer-readable medium of claim 10, wherein deriving a halftone pattern for the iteration based on a start location in the first halftone pattern further comprises:
rotating the first halftone pattern by R bits to obtain a second halftone pattern, wherein R is the bit position of the start location in the first halftone pattern for the iteration;
repeatedly concatenating the second halftone pattern to obtain a concatenated pattern that is greater than or equal to the second data width; and
truncating any terminal portion of the concatenated pattern so that the resulting derived pattern is of the second data width.

12. The computer-readable medium of claim 10, wherein the method is performed using a Digital Signal Processor coupled to a printer.

13. The computer-readable medium of claim 11, further comprising storing distinct derived halftone patterns that correspond to distinct start locations in the first halftone pattern in a table.

14. The computer-readable medium of claim 11, further comprising storing distinct derived halftone patterns that correspond to distinct start locations in the first halftone pattern in distinct processor registers.

15. The computer-readable medium of claim 10, wherein the method is used to perform halftoning operations on at least one entire image.

16. A system comprising a computer coupled to a printer, wherein the computer and printer perform steps in a method performing halftoning operations on image data using a first halftone pattern with a first data width on a SIMD-capable processor with a second data width, wherein the method comprises at least one iteration and the second data width is not an integral multiple of the first data width, the method comprising:
deriving a halftone pattern for the iteration based on a start location in the first halftone pattern, wherein the derived halftone pattern is of the second data width;
loading image data for the at least one iteration, until the image data is exhausted, or until the image data occupies the entire width of a second register in the processor; and
performing halftone computations on the image data using the derived halftone pattern.

17. The system of claim 16, wherein deriving a halftone pattern for the iteration based on a start location in the first halftone pattern further comprises:
rotating the first halftone pattern by R bits to obtain a second halftone pattern, wherein R is the bit position of the start location in the first halftone pattern for the iteration;
repeatedly concatenating the second halftone pattern to obtain a concatenated pattern that is greater than or equal to the second data width; and
truncating any terminal portion of the concatenated pattern so that the resulting derived pattern is of the second data width.

18. The system of claim 17, further comprising storing distinct derived halftone patterns that correspond to distinct start locations in the first halftone pattern in a table.

19. The system of claim 17, further comprising storing distinct derived halftone patterns that correspond to distinct start locations in the first halftone pattern in distinct processor registers.

20. The system of claim 15, wherein the method is used to perform halftoning operations on at least one entire image.
